(19) United States
(12) Patent Application Publication
(10) Pub. No.: US 2009/0271827 A1
(43) Pub. Date: Oct. 29, 2009

(54) TV ON/OFF TIMER FEATURE FOR DISPLAYING USER-SELECTED NON-TV TUNER CONTENT

(75) Inventor: Mahyar Nejat, La Jolla, CA (US)

Correspondence Address: ROGITZ & ASSOCIATES, 750 B STREET, SUITE 3120, SAN DIEGO, CA, 92101, US

(73) Assignees: Spny Corporation; Sony Electronics Inc.

(21) Appl. No.: 12/111,298

(22) Filed: Apr. 29, 2008

(51) Int. Cl. G06F 13/10; G08B 1/08

(52) U.S. Cl. 725/59; 340/309.16

(57) ABSTRACT

A TV viewer may select a wake-up or “on” time at which a TV is automatically energized. The viewer may also select a content source such as a music player, a disk player, a game console, and the like from which content is automatically presented on the TV at the “on” time.

### FIELD OF THE INVENTION

The present invention relates generally to allowing viewers to select not only a TV “on” time but also non-TV tuner content to be automatically displayed at the selected time.

### BACKGROUND OF THE INVENTION

As understood herein, it is possible to provide TV viewers with the option of causing the TV to automatically turn on at a viewer-selected time in the future. As also understood herein, however, it would be desirable to permit the user to define not only the time but also non-TV tuner content such as videos, music, photos, and the like for automatic display of the selected content at the selected time.

### SUMMARY OF THE INVENTION

A computer-implemented method presents a graphic user interface (GUI) on a screen of a TV listing plural content sources. A viewer selection of a first one of the sources is received, with the first one of the sources being a non-TV tuner source. At a viewer-defined future time the TV is automatically energized and content is automatically presented from the first one of the sources in accordance with the viewer selection.

The content sources may be listed by, e.g., TV input port type or by device type. The source(s) may provide digital still images, music, video content.

In another aspect, a system has a TV display, a processor associated with the TV display, and a tuner controllable by the processor. The processor can be configured to automatically energize the TV at a user-defined time to automatically display content from a user-designated non-TV tuner source.

In another aspect, an apparatus allows a user to cause a TV to automatically turn on at a user-established future time to automatically present non-TV tuner content at the user-established future time.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting schematic block diagram of a system in accordance with present principles;

FIG. 2 is a flow chart of logic that may be employed by the system of FIG. 1;

FIG. 3 is a screen shot of a non-limiting example graphic user interface (GUI) that can be used to allow a viewer to select a TV “on” content source(s); and

FIG. 4 is an alternate screen shot of a non-limiting example graphic user interface (GUI) that can be used to allow a viewer to select a TV “on” content source(s).

### DETAILED DESCRIPTION OF THE PREFERRED EMBODIMENT

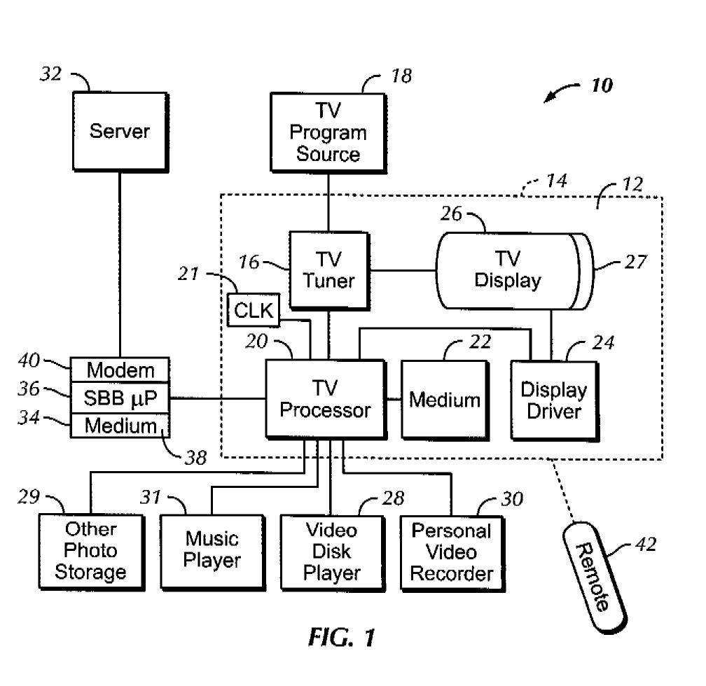

Referring initially to FIG. 1, a system is shown, generally designated 10, which includes a television 12 defining a TV chassis 14 and receiving, through a TV tuner 16 from a cable or satellite or other source or sources 18 audio video TV programming. The tuner 16 may be contained in the set box described below.

The TV 12 typically includes a TV processor 20 accessing a clock 21 and a tangible computer readable medium 22. The tangible computer readable medium 22 may be established by, without limitation, solid state storage, optical or hard disk storage, etc. The medium 22 may store software executable by the TV processor 20 to, e.g., control a display driver 24 that drives a TV visual display 26 in accordance with one or more settings such as brightness, contrast, and the like. The medium 22 may store code embodying logic herein. The display 26 may be a flat panel matrix display, cathode ray tube, or other appropriate video display, and typically is associated with one or more audio speakers 27. The medium 22 may also contain additional code including backend software executable by the TV processor 20 for various non-limiting tasks. One or more of the processors described herein may execute the logic below, which may be stored as computer code on one or more the computer readable media described herein.

In the non-limiting embodiment shown in FIG. 1 the TV 12 may receive content from external components such as but not limited to a video disk player 28 such as a Blu-Ray or DVD player. The disk player 28 may alternatively be embodied as a game console such as a Sony Play Station™. The player 28 may be able to store still digital photographs that a user can load into the player from a digital camera. Other photographic storage 29 such as but not limited to a digital camera storage medium may also provide photo content to the processor 20.

Still further, a personal video recorder (PVR) 30 that can contain audio-video streams on a hard disk drive may provide content to the TV processor 20. Also, a music player 31 can be provided to send content such as music and, in some implementations, video to the TV processor. Typically, the photo storage 29 and potentially other content sources communicate with the TV processor 20 through a universal serial bus (USB) port of the TV 12, while the music player 31 and potentially other content sources communicate with the TV processor 20 through a digital media (DM) port of the TV 12.

Additionally, the TV 12 can communicate via a network such as the Internet with a server 32. To this end, the TV 12 may be Internet-enabled, although it is to be understood that the server 32 maybe combined with the TV program source 18 when the source 18 is a remote entity accessible over a wide area network, in which case no modem need be provided, with the TV sending signals through a reverse link to the source 18/server 32.

In the non-limiting embodiment shown, the server 32 is separate from tire source 18 and the TV 12 communicates with the server 32 through a set-back box (SBB) 34. In some implementations a set-top box (STB) may be used, and the SBB/STB may itself include the tuner 16 or otherwise communicate with the source 18.

In any case, the SBB 34 shown in FIG. 1 may include a SBB processor 36 and SBB computer readable medium 38. The SBB 34 may also include a network interface such as but not limited to a modem 40 to communicate with the server 32 over the Internet. In other implementations the modem 40 may be incorporated into the TV chassis 14.

A wireless remote control 42 can be provided to input commands such as the below-described subtitle position commands into the system 10. The remote control 42 can be a conventional TV remote control or other portable hand-held device.

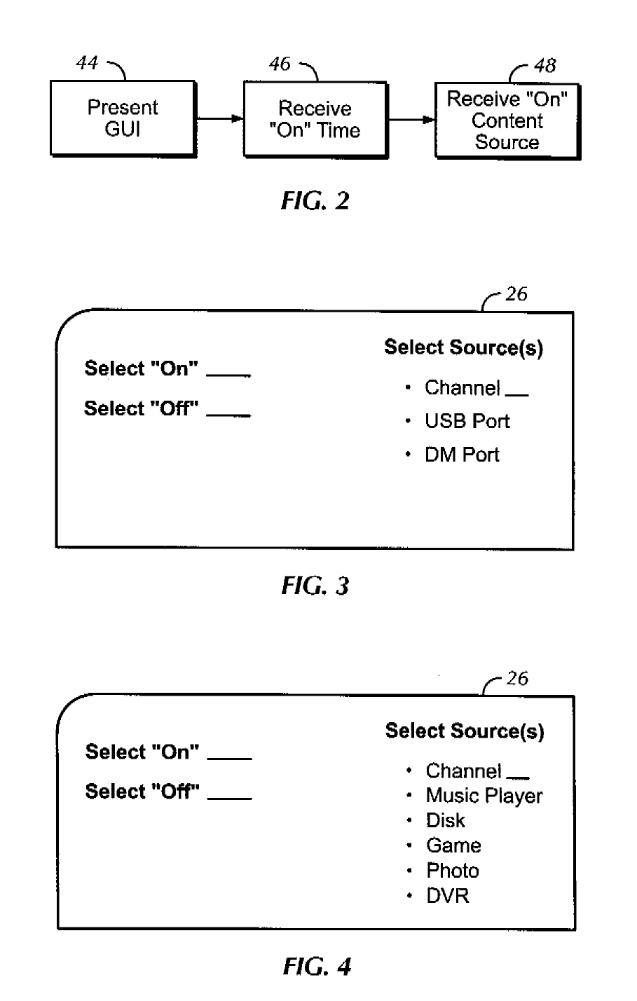

Now referring to FIG. 2, at block 44 a TV “on” user interface (GUI) such as the example GUI shown in FIG. 3 or FIG. 4 and described below is presented on the display 26. Typically this occurs in response to a viewer using the remote control 42 to navigate through menus, e.g., to select a “settings” entry on a main menu to invoke the “TV on” lime and content selection feature discussed herein.

At block 46, a viewer selection of an “on” time is received. An “off” time may also be received. Then, at block 48 a viewer selection of the source of content to be automatically displayed at the “on” time is received. The selected source may be by device name, e.g., “disk player” or “music player”, or by input port, e.g., “USB port” or “DM port”. More than one source may be selected in appropriate circumstances. For example, the viewer may be permitted to select to have a photo from one source displayed on the display 26 while music from, e.g., the music player 31 is played on the speakers 27. When both genres of content are provided by a single source, the viewer may be permitted to select both from the source. It is to be understood that the viewer may also select a TV channel to be automatically tuned to at the selected “on” time.

Thus, in one implementation the TV processor 20 (alternatively, the set box processor 36) need not “know” what specific sources of content are attached to it; rather, it will automatically display content from a selected port. The processor can cause the selected source to automatically energize, if not already energized, at the selected “on” time. In other implementations the processor may “know” what sources are connected to it and may list each source on the GUI for selection thereof by a viewer. In any case, at block 50, at the selected “on” time as indicated by, e.g., the clock 21, the processor automatically energizes the TV and, if appropriate, the selected content source, and automatically displays content from the selected source.

For the above-described wake up feature of the content source, a technology such as wake on LAN (WoL) can be used by the processor to trigger the automatic power on of the content source, which may maintain a small portion of itself energized to detect power-on signals. WoL works with all network traffic including Internet traffic where a “magic” packet can be sent and the listening device (such as the music player or PVR) can receive the packet, check it and thus, power itself up.

FIG. 3 shows an example GUI that may be presented when a viewer navigates to it through upper level menus such as a “settings” menu. In one implementation the GUI is configured in conjunction with the present assignee's cross-media bar (XMB) GUI.

As shown at the left side of FIG. 3, the viewer may be provided with entry fields into which “on” and “off” times may be input using, e.g., the key pad on the remote control 42. Or, time increments in, e.g., fifteen minute intervals may be presented through which the viewer can scroll and then select the desired time.

On the right side of FIG. 3, the user is presented with a list of sources from which content is to be displayed at the selected “on” time. In the non-limiting embodiment shown, the viewer may select a TV channel to be automatically tuned to and displayed at the selected “on” time, but the viewer is also presented with the option to select non-TV tuner content in the form of input port. Thus, for example, the viewer may select whatever content is input from the TV's USB port or DM port.

In another embodiment as shown in FIG. 4, the viewer may be provided with entry fields into which “on” and “off” times may be input using, e.g., the key pad on the remote control 42. Or, time increments in, e.g., fifteen minute intervals may be presented through which the viewer can scroll and then select the desired time.

On the right side of FIG. 4, the user is presented with a list of sources from which content is to be displayed at the selected “on” time. In the non-limiting embodiment shown, the viewer may select a TV channel to be automatically tuned to and displayed at the selected “on” time, but the viewer is also presented with the option to select non-TV tuner content in the form of device type. Thus, for example, the viewer may select content from the music player, the disk player, the game console, the photo source, or the PVR. More than one source may be selected so that, e.g., a photo from the photo source and music from the music player are both automatically displayed at the selected “on” time.

If desired, the viewer may be given the opportunity to select not only the source but also a specific piece of content from the source. To this end, the processor may communicate with the various sources to obtain a list of content from each. Or, in a simplified embodiment the processor automatically displays, at the selected “on” time, whatever content the selected source happens to send, e.g., the first song on a music album or the first photo in a photo album.

While the particular TV ON/OFF TIMER FEATURE FOR DISPLAYING USER-SELECTED NON-TV TUNER CONTENT is herein shown and described in detail, it is to be understood that the subject matter which is encompassed by the present invention is limited only by the claims.

What is claimed is:

1. A computer-implemented method comprising:
presenting a graphic user interface (GUI) on a screen of a TV listing plural content sources;
receiving a viewer selection of at least a first one of the sources, the first one of the sources being a non-TV tuner source; and
at a viewer-defined future time, automatically energizing the TV and automatically presenting content from the first one of the sources in accordance with the viewer selection.

2. The method of claim 1, wherein the content sources are listed by TV input port type.

3. The method of claim 1, wherein the content sources are listed by device type.

4. The method of claim 1, wherein the first one of the sources provides digital still images.

5. The method of claim 1, wherein the first one of the sources provides music.

6. The method of claim 1, wherein the first one of the sources provides video content.

7. A system, comprising:
a TV display;
a processor associated with the TV display; and
a tuner controllable by the processor; wherein
the processor is configured to automatically energize the TV at a user-defined time to automatically display content from a user-designated source, the source not being a TV tuner.

8. The system of claim 7, wherein the processor lists content sources by TV input port type for user selection thereof.

9. The system of claim 7, wherein the processor lists content sources by device type for user selection thereof.

10. The system of claim 7, wherein the source provides digital still images.

11. The system of claim 7, wherein the source provides music.

12. The system of claim 7, wherein the source provides video content.

13. Apparatus allowing a user to cause a TV to automatically turn on at a user-established future time to automatically present non-TV tuner content at the user-established future time.

14. The apparatus of claim 13, wherein the content is from at least one source.

15. The apparatus of claim 14, wherein the TV automatically energizes the source at the user-established time.

16. The apparatus of claim 14, wherein the source provides digital still images.

17. The apparatus of claim 14, wherein the source provides music.

18. The apparatus of claim 14, wherein the source provides video.

19. The apparatus of claim 13, wherein the apparatus presents a list of sources by TV input port type for selection of at least one source from the list.

20. The apparatus of claim 13, wherein the apparatus presents a list of sources by device type for selection of at least one source from the list.
